(19) United States
(12) Patent Application Publication
(10) Pub. No.: US 2012/0176495 A1
(43) Pub. Date: Jul. 12, 2012

(54) System to improve face image acquisition

(75) Inventors: Robert E. De Mers, Nowthen, MN (US); Rand Whillock, North Oaks, MN (US)

(73) Assignee: Honeywell International Inc., Morristown, NJ (US)

(21) Appl. No.: 12/930,594

(22) Filed: Jan. 11, 2011

(51) Int. Cl. H04N 7/18

(52) U.S. Cl. 348/143; 348/E07.09

(57) ABSTRACT

A process to capture in-focus face images of a subject looking at a display unit. The system alters the content of the display to get the subject to move into the optimal focus position for a camera. If the subject is farther from the camera than an optimal distance, the displayed content is altered to cause the subject to move closer to the display unit. If the subject is closer to the display unit than an optimal distance, the displayed content is altered to cause the subject to move further away from the display unit. If the subject is at an optimal distance, the displayed content is maintained or corrected. An image of the subject's face is acquired, and the image is processed.

### TECHNICAL FIELD

The present disclosure relates to face image acquisition, and in an embodiment, but not by way of limitation, to a system and method to alter the content of a video display unit so as to cause a person to move closer to, or farther away from, the video display unit.

### BACKGROUND

Face acquisition systems employ a camera to capture an image of a person for a variety of purposes including video conferencing, image storage and security applications where a good quality image of a subject is desired. Such systems may be installed in connection with an automated teller machine (ATM) kiosk, in the vicinity of a security gate or checkpoint, or in any other environment where a user interacts with a display. There is a desire that these systems be usable by everyone in the population including hearing impaired individuals. These applications require the captured image of the person to be of sufficient quality to allow for the desired use. In some systems, a clear image is captured by using an auto-focus camera.

In many situations, such as in cell phones and lower cost camera installations, there may be space, power, budget, or other factors that prevent the use of an auto-focus camera. In such situations, a fixed-focus camera has to be used. Unfortunately, the use of a fixed-focus camera reduces the chances of capturing a focused image. Some systems use audio cues or mechanical guides to direct a user to the best camera focus location, but these can be difficult to use and there are many situations, such as with hearing impaired individuals, where this approach is not practical. This document describes a method to position a subject at the proper location in front of a fixed focus imaging system that does not require audio or mechanical cues. The proposed invention could be used by hearing impaired people as well as unimpaired people.

### BRIEF DESCRIPTION OF THE DRAWINGS

FIG. 1 illustrates an example embodiment of a face image capture system.

FIG. 2 illustrates an example embodiment of a process of capturing a focused image in a face image capture system.

FIG. 3 illustrates another example embodiment of a process of capturing a focused image in a face acquisition system.

FIG. 4 illustrates an example embodiment of a computer processor system that can be used in connection with one or more embodiments of this disclosure.

### DETAILED DESCRIPTION

In an embodiment, changes are made to a user interface of a computer system, and these changes cause a user to move closer to, or farther away from, the display unit of the computer system. As a result, a user at some point will move through a position of best focus for a fixed-focus camera that is set up to capture images of the person at the user interface of the computer system.

In order to influence the position of a user at the display unit, an embodiment takes advantage of the limitations of human vision such as limits on readability, resting point of focus (RPF) distance, resting point of accommodation (RPA) distance, perceivable font sizes, and the like. Accommodation is the movement of the eyes toward each other so as to keep both eyes on an object as the object gets closer and closer to a person. When the object gets too close, the user is unable to maintain accommodation and a double image results (i.e., the user becomes cross-eyed). The resting point of focus is the distance at which eyes focus with the least amount of effort, and it is commonly shorter than the resting point of accommodation.

Additionally, an embodiment takes advantage of predictable patterns of human behavior. For example, as the size of text on a display unit is reduced, a person will move closer to the display unit to improve their ability to read the text. In contrast, as the size of text on the display unit is increased, a person will move farther away from the display until that person reaches a comfortable reading distance. This distance is typically at the resting point of accommodation, which is approximately 45 inches from the display. In an embodiment, the screen image is rendered more fuzzy or less fuzzy to cause a user to move closer to or farther away from the screen. If the quality of the displayed is adjusted this manner, a user will subconsciously move their head to a position where they are at the optimal display.

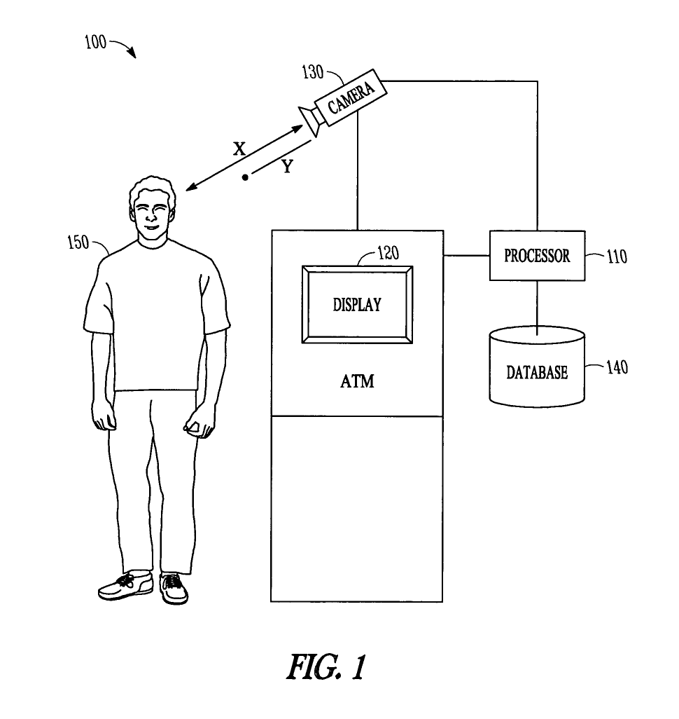

FIG. 1 illustrates an example system 100 to improve face image acquisition. The system 100 includes a computer processor 110, a display unit 120 coupled to the processor 110, a fixed-focus camera 130, and a database 140. The database 140 contains collected face images. FIG. 1 further illustrates a person 150 whose head and eyes are at a distance X from the display unit 120. A point Y is the focal point of the fixed-focus camera. As indicated above, the content of the display unit 120 can be altered so as to cause the person 150 to move closer to, or farther away from, the display unit.

In an embodiment, the processor 110 is configured to alter content on the display unit 120. This alteration will cause a system user at the display unit to move closer to, or farther from, the display unit. This in turn will cause the user to move through a focal point of the fixed-focus camera 130, and the processor 110 is configured to capture an image of the user as the user moves through the focal point of the fixed-focus camera. The processor 110 can also be configured to perform the desired application on the collected images. These operations can include the transmission of the face image to another system, processing of the face images for security purposes or storage for later use.

In another embodiment, the processor 110 can determine a size of the head of the user at the display unit. The size of a person's head is a measure of the distance that they are from the camera. Using a known average head size and the size of the head image, the distance from the subject to the camera can be calculated. This is useful because when the system detects an out of focus image, it does not know if the out of focus image is caused by the user being too close to, or too far away from, the fixed-focus camera 130. However, by examining the apparent head size of the user, the system can determine that the user is too close (head size is above a threshold for a normal head) or too far (head size is below a threshold for a normal head). With this information, the system can alter the display to move a user closer to or farther away from the display unit as needed.

The processor 110 can alter the content on the display unit by enlarging the size of content on the display unit, reducing the size of the content on the display unit, and/or changing the font of the content on the display unit. As noted, this will cause the user to move closer to or farther away from the display unit. In an alternative embodiment, the processor 110 can cause the content on the display unit to be intentionally distorted (e.g., made fuzzy) so as to appear to be “out of focus,” thereby causing a user to move closer to or farther away from the screen in an attempt to make the screen more readable. Such a fuzzy image, in most cases, will cause the user to move closer to the display unit when the distorted content is displayed on the display unit. Other methods that cause slight viewing discomfort to the user can also be used to cause the user to move to the desired distance. These methods could include moving the display slightly to cause jitter, or reducing the contrast of the display making it harder to read. In yet another embodiment, the processor can capture a plurality of images of the user at the display unit, and analyze the plurality of captured images to determine which of the captured images is in focus. With this embodiment, the system does not need to acquire any information about the location of the user in relation to the display unit.

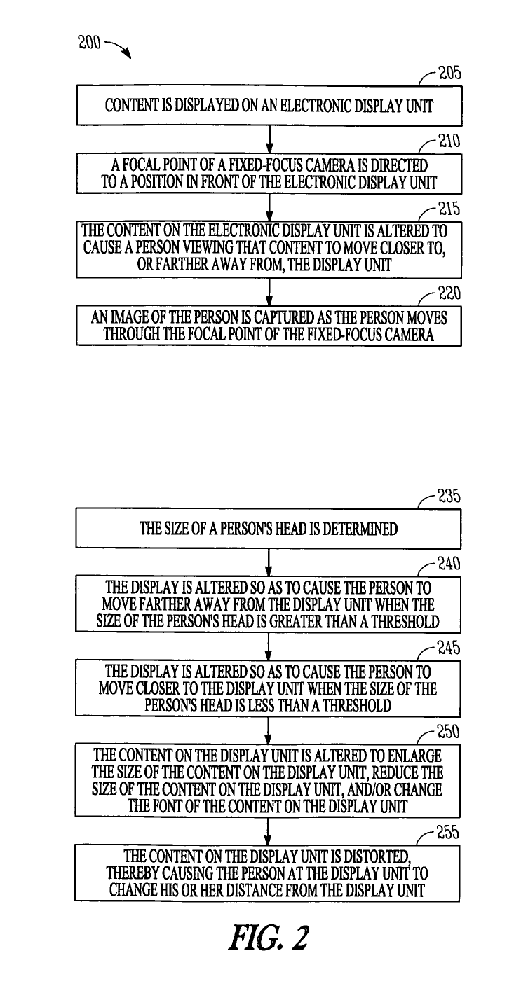

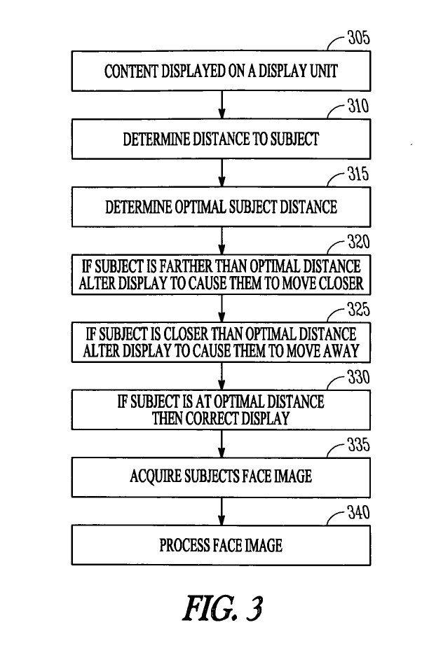

FIGS. 2 and 3 are example flowcharts of the functions of a face image acquisition system such as the system 100 illustrated in FIG. 1. FIGS. 2 and 3 include a number of process blocks 205-255 and 305-340 respectively. Though arranged serially in the examples of FIGS. 2 and 3, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIG. 2, at 205, content is displayed on an electronic display unit. In 210 a focal point of a fixed-focus camera is directed to a position in front of the electronic display unit, and at 215, the content on the electronic display unit is altered to cause a person viewing that content to move closer to, or farther away from, the display unit. As previously noted, this causes a person at the display unit to move through the focal point of the fixed-focus camera. An image of the person is captured as the person moves through the focal point of the fixed-focus camera at 220.

In another embodiment, illustrated as starting at 235, the size of a person's head is determined. As noted previously, determining the size of a person's head allows the system to determine if a person is too close to or too far away from the display unit. At 240, the display is altered so as to cause the person to move farther away from the display unit when the size of the person's head is greater than a threshold, and at 245, the display is altered so as to cause the person to move closer to the display unit when the size of the person's head is less than a threshold.

At 250, the content on the display unit is altered to enlarge the size of the content on the display unit, reduce the size of the content on the display unit, and/or change the font of the content on the display unit. At 255, the content on the display unit is distorted (e.g., made fuzzy), thereby causing the person at the display unit to change his or her distance from the display unit.

Referring now to FIG. 3, at 305, content is displayed on a display unit. At 310, the system determines the distance the distance to the subject. This can be done using an active range detection device or can be done algorithmically. An algorithm to determine the range of the subject could estimate the range based on the size of the subjects head in the image seen by the camera. The system could also analyze the collected image to determine the subject distance based on the whether the image is in focus or not. The severity that the image is out of focus correlates with the distance the subject is away from the optimal focal point. Step 315 determines the optimal subject distance. This can be set by knowing the focal distance of the camera or could be determined by looking at how much a collected image is out of focus. At 320 if the subject is father away than the optimal distance the display is altered to cause them to move closer. This could be done using a number of methods including making the display fuzzy and appearing out of focus, making displayed text small and hard to read or making the display lower in brightness. At 325 similar methods are used in the subject is determined to be too near the display. At 330 if the subject is at the optimal distance the display can be corrected and shown without distortions. If the subject in not at the correct distance, steps 305 through 325 can be repeated. If the subject is at the correct distance step 335 acquires an image of their face with the camera and step 340 processes the face image per the desired application. This processing could include storage, transmission or face recognition depending on the target application.

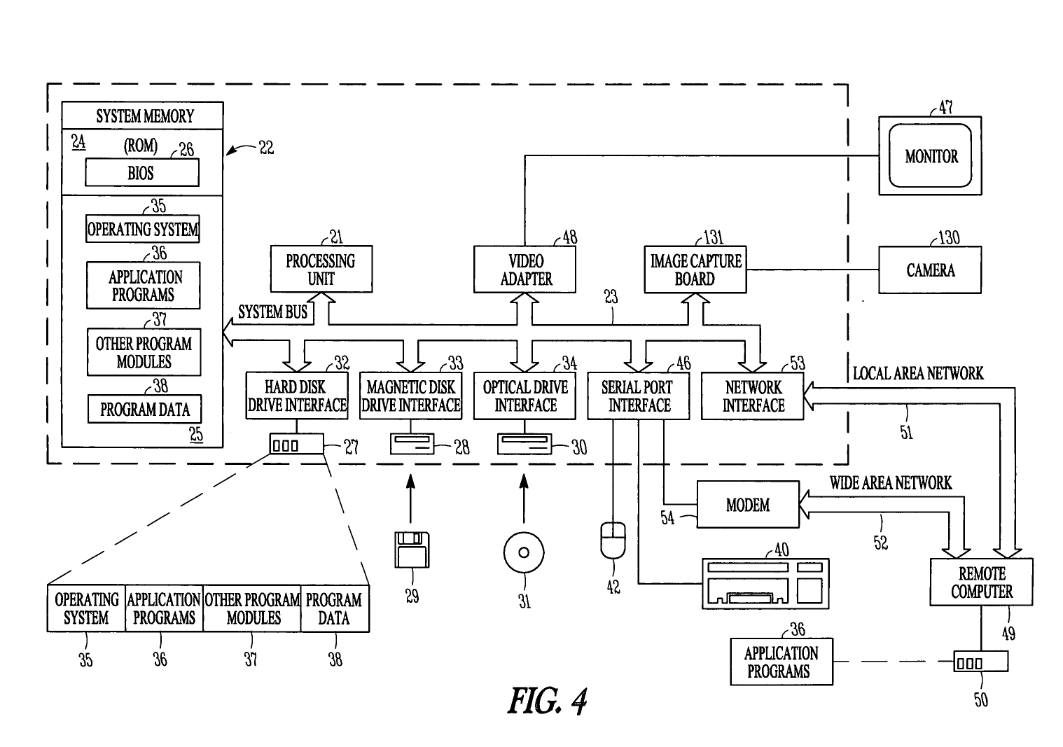

FIG. 4 is an overview diagram of a hardware and operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The system bus 23 can be coupled to an image capture board 131, which in turn can be coupled to a fixed-focus camera 130.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 3 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### Example Embodiments

In Example No. 1, a system includes a processor, a display unit coupled to the processor, and a fixed-focus camera coupled to the processor. The system also includes a method for determining the range to a subject in front of the system. The system can optionally include a database coupled to the processor, wherein the database includes one or more images of one or more persons. The processor is configured to alter content on the display unit, such that a system user at the display unit will move closer to or farther from the display unit, thereby causing the user to move through a focal point of the fixed-focus camera.

In Example No. 2, a system includes the features of Example No. 1, and further optionally includes a processor configured to capture an image of the user as the user moves through the focal point of the fixed-focus camera.

In Example No. 3, a system includes the features of Example Nos. 1-2, and further optionally includes an active system, such as a laser range finder, to measure the distance to the subject.

In Example No. 4, a system includes the features of Example Nos. 1-3, and further optionally includes a method to transmit the captured face image to another system.

In Example No. 5, a system includes the features of Example Nos. 1-4, and further optionally includes a processor configured to use size features, such as the head size, to alter the content on the display unit so as to cause the user to move farther away from the display unit when the size is greater than a threshold, and alter the content on the display unit so as to cause the user to move closer to the display unit when the size is less than a threshold.

In Example No. 6, a system includes the features of Example Nos. 1-5, and further optionally includes a system wherein the alteration of the content on the display unit comprises one or more of enlarging a size of the content on the display unit, reducing the size of the content on the display unit, and changing a font of the content on the display unit.

In Example No. 7, a system includes the features of Example Nos. 1-6, and further optionally includes a processor configured to display the content on the display unit such that the content is distorted, thereby causing the user at the display unit to change his distance from the display unit.

In Example No. 8, a system includes the features of Example Nos. 1-7, and further optionally includes a processor configured to capture a plurality of images of the user, and analyze the plurality of images to identify a captured image that is in focus.

In Example No. 9, a process includes displaying content on an electronic display unit, directing a focal point of a fixed-focus camera to a position in front of the electronic display unit, and altering the content on the electronic display unit to cause a person viewing the content to move closer to or farther away from the electronic display unit, thereby causing the person to move through the focal point of the fixed-focus camera.

In Example No. 10, a process includes the features of Example No. 9, and further optionally includes capturing an image of the person as the person moves through the focal point of the fixed-focus camera.

In Example No. 11, a process includes the features of Example Nos. 9-10, and further optionally includes comparing the captured image with one or more images stored in a database.

In Example No. 12, a process includes the features of Example Nos. 9-11, and further optionally includes a process wherein the comparison of the captured image with the one or more images stored in the database results in an identification of the person.

In Example No. 13, a process includes the features of Example Nos. 9-12, and further optionally includes determining a size of the person's head, altering the content on the electronic display unit so as to cause the person to move farther away from the electronic display unit when the size is greater than a threshold, and altering the content on the electronic display so as to cause the person to move closer to the electronic display unit when the size is less than a threshold.

In Example No. 14, a process includes the features of Example Nos. 9-13, and further optionally includes a process wherein the altering the content on the electronic display unit comprises one or more of enlarging the size of the content on the electronic display unit, reducing the size of the content on the electronic display unit, and changing a font of the content on the electronic display unit.

In Example Nos. 15, a process includes the features of Example Nos. 9-14, and further optionally includes displaying content on the electronic display unit that is distorted, thereby causing the person at the electronic display unit to change his distance from the electronic display unit.

In Example No. 16, a computer readable medium includes instructions that when executed by a processor execute a process including displaying content on an electronic display unit, directing a focal point of a fixed-focus camera to a position in front of the electronic display unit, and altering the content on the electronic display unit so as to cause a person viewing that content to move closer to or farther away from the electronic display unit, thereby causing the person to move through the focal point of the fixed-focus camera.

In Example No. 17, a computer readable medium includes the features of Example No. 16, and further optionally includes instructions for capturing an image of the person as the person moves through the focal point of the fixed-focus camera.

In Example No. 18, a computer readable medium includes the features of Example Nos. 16-17, and further optionally includes instructions for comparing the captured image with one or more images stored in a database.

In Example No. 19, a computer readable medium includes the features of Example Nos. 16-18, and further optionally includes instructions wherein the altering the content on the electronic display unit comprises one or more of enlarging a size of the content on the electronic display unit, reducing the size of the content on the electronic display unit, and changing a font of the content on the electronic display unit.

In Example No. 20, a computer readable medium includes the features of Example Nos. 16-19, and further optionally includes instructions for displaying content on the electronic display unit such that the content is out of focus, thereby causing the person at the electronic display unit to change his distance from the electronic display unit.

In Example No. 21, a process includes displaying content on an electronic display unit, determining the distance between a person and a camera that is associated with the electronic display unit, determining an optimal distance between the person and the camera, when the person is farther from the camera than the optimal distance, altering the displayed content to cause the person to move closer to the electronic display unit, when the person is closer to the camera than the optimal distance, altering the displayed content to cause the person to move further away from the display unit, when the person is at the optimal distance, maintaining or correcting the displayed content, acquiring an image of the person's face, and processing the image of the person's face.

In Example No. 22, a process includes the features of Example No. 21, and further optionally includes determining the distance between the person and the camera by using an active range detection device or determining the distance algorithmically.

In Example No. 23, a process includes the features of Examples Nos. 21-22, and further optionally includes determining the optimal distance by determining a focal point of the camera or determining a measure indicating that the acquired image is out of focus.

In Example No. 24, a process includes the features of Example Nos. 21-23, and further optionally includes altering the displayed content by making the displayed content fuzzy, altering a size of text on the displayed content, or decreasing the brightness of the displayed content.

Thus, an example system, method and machine readable medium for acquiring face images has been described. Although specific example embodiments have been described, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived there from, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)). Consequently, a machine-readable medium can be either tangible or intangible in nature.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A process comprising:
displaying content on an electronic display unit;
determining a distance between a person and a camera that is associated with the electronic display unit;
determining an optimal distance between the person and the camera;
when the person is farther away from the camera than the optimal distance, altering the displayed content to cause the person to move closer to the electronic display unit;
when the person is closer to the camera than the optimal distance, altering the displayed content to cause the person to move farther away from the display unit;
when the person is at the optimal distance, maintaining or correction the displayed content;
acquiring an image of the person's face; and
processing the image of the face.

2. The process of claim 1, wherein determining the distance between the person and the camera comprises using an active range detection device or determining the distance algorithmically.

3. The process of claim 1, wherein determining the optimal distance comprises determining a focal point of the camera or determining a measure that the acquired image is out of focus.

4. The process of claim 1, wherein altering the displayed content comprises making the displayed content fuzzy, altering a size of text on the displayed content, or decreasing the brightness of the displayed content.

5. A system comprising:
a processor;
a display unit coupled to the processor;
a fixed-focus camera coupled to the processor; and
wherein the processor is configured to alter content on the display unit, such that a system user at the display unit will move closer to or farther from the display unit, thereby causing the user to move through a focal point of the fixed-focus camera.

6. The system of claim 5, comprising a database coupled to the processor, the database including one or more images of one or more persons.

7. The system of claim 6, wherein the processor is configured to capture an image of the user as the user moves through the focal point of the fixed-focus camera.

8. The system of claim 7, comprising an active system to determine a distance between the fixed-focus camera and the user.

9. The system of claim 7, wherein the processor is configured to transmit a captured face image to another system.

10. The system of claim 5, wherein the processor is configured to:
alter the content on the display unit so as to cause the user to move farther away from the display unit when a size of the user is greater than a threshold; and
alter the content on the display unit so as to cause the user to move closer to the display unit when the size of the user is less than a threshold.

11. The system of claim 5, wherein the alteration of the content on the display unit comprises one or more of enlarging a size of the content on the display unit, reducing the size of the content on the display unit, and changing a font of the content on the display unit.

12. The system of claim 5, wherein the processor is configured to display the content on the display unit such that the content is distorted, thereby causing the user at the display unit to change his distance from the display unit.

13. The system of claim 5, wherein the processor is configured to:
capture a plurality of images of the user; and
analyze the plurality of images to identify a captured image that is in focus.

14. A process comprising:
displaying content on an electronic display unit;
directing a focal point of a fixed-focus camera to a position in front of the electronic display unit; and
altering the content on the electronic display unit to cause a person viewing the content to move closer to or farther away from the electronic display unit, thereby causing the person to move through the focal point of the fixed-focus camera.

15. The process of claim 14, comprising capturing an image of the person as the person moves through the focal point of the fixed-focus camera.

16. The process of claim 15, comprising comparing the captured image with one or more images stored in a database.

17. The process of claim 16, wherein the comparison of the captured image with the one or more images stored in the database results in an identification of the person.

18. The process of claim 16, comprising:
determining a size of the person's head;
altering the content on the electronic display unit so as to cause the person to move farther away from the electronic display unit when the size is greater than a threshold; and
altering the content on the electronic display so as to cause the person to move closer to the electronic display unit when the size is less than a threshold.

19. The process of claim 14, wherein the altering the content on the electronic display unit comprises one or more of enlarging the size of the content on the electronic display unit, reducing the size of the content on the electronic display unit, and changing a font of the content on the electronic display unit.

20. The process of claim 14, comprising displaying content on the electronic display unit that is out of focus, thereby causing the person at the electronic display unit to change his distance from the electronic display unit.
